(19) United States
(12) Patent Application Publication
(10) Pub. No.: US 2018/0205729 A1
(43) Pub. Date: Jul. 19, 2018

(54) METHOD AND APPARATUS FOR ENCRYPTION, DECRYPTION AND AUTHENTICATION

(71) Applicant: GM GLOBAL TECHNOLOGY OPERATIONS LLC, Detroit, MI (US)

(72) Inventor: Daniel P. Carlesimo, Macomb Township, MI (US)

(21) Appl. No.: 15/405,638

(22) Filed: Jan. 13, 2017

(51) Int. Cl. H04L 29/06

(52) U.S. Cl. CPC H04L 63/0876; H04L 63/123; H04L 63/0435; H04L 63/061

(57) ABSTRACT

A method, apparatus and system for encryption, decryption and/or authentication are provided. The method includes: generating vehicle data based on information detected at a vehicle component; generating a dynamic secret key based on a symmetric secret key stored at a first device and at least one from among information about a vehicle and information about a driver of a vehicle; and generating a message authentication code to authenticate the vehicle data by using the generated dynamic secret key. The method, apparatus and system may be used to authenticate or encrypt and decrypt messages in a vehicle communication network.

### INTRODUCTION

Apparatuses and methods consistent with exemplary embodiments relate to encryption, decryption and authentication. More particularly, apparatuses and methods consistent with exemplary embodiments relate to encryption, decryption and authentication of data on shared environment communication platforms.

### SUMMARY

One or more exemplary embodiments provide a method and an apparatus that encrypt, decrypt and authenticate data on shared environment communication platforms. More particularly, one or more exemplary embodiments provide a method and an apparatus that encrypt, decrypt and authenticate data on shared environment communication platforms such as an embedded vehicle network.

According to an aspect of an exemplary embodiment, a method for authenticating data is provided. The method includes generating vehicle data based on information detected at a vehicle component; generating a dynamic secret key based on a symmetric secret key stored at a first device and at least one from among information about a vehicle and information about a driver of a vehicle; and generating a message authentication code to authenticate the vehicle data by using the generated dynamic secret key.

The information about a vehicle may include at least one from among identification information of an electronic controller unit, identification information of an electronic controller unit group, identification information corresponding to a network, identification information of a vehicle, and information corresponding to a vehicle function.

The information about a driver may include at least one from among identification information of the driver, authentication information of the driver, dynamically generated information based on driver actions, and vehicle settings corresponding to the driver.

The method may further include encrypting the vehicle data by using the generated dynamic secret key.

The method may further include adding the encrypted vehicle data to a message payload; and transmitting the message authentication code and the message payload to a second device.

The method may further include adding the message authentication code to a message payload; and transmitting the message payload to a second device.

The method may further include generating a second dynamic secret key based on the symmetric secret key stored at the first device and the at least one from among information about the vehicle and information about the driver of a vehicle; and encrypting the vehicle data by using the generated second dynamic secret key.

According to an aspect of another exemplary embodiment, a method for authenticating data is provided. The method includes receiving vehicle data and a message authentication code at a second device; generating a dynamic secret key based on a symmetric secret key stored at the second device and at least one from among information about a vehicle and information about a driver of a vehicle; and validating the received message authentication code and vehicle data based on the generated dynamic secret key.

The information about a vehicle may include at least one from among identification information of an electronic controller unit, identification information of an electronic controller unit group, identification information corresponding to a network, identification information of a vehicle, and information corresponding to a vehicle function.

The information about a driver may include at least one from among identification information of the driver, authentication information of the driver, dynamically generated information based on driver actions, and vehicle settings corresponding to the driver.

The vehicle data may include encrypted vehicle data. The method further include decrypting the vehicle data by using the generated dynamic secret key.

The method further include performing a vehicle function corresponding to the decrypted vehicle data at the second device in response to the message payload being validated based on the message authentication code.

The method further include generating a second dynamic secret key based on the symmetric secret key stored at the first device and the at least one from among information about the vehicle and information about the driver of a vehicle; and decrypting the vehicle data by using the generated second dynamic secret key.

According to an aspect of another exemplary embodiment, a system for authenticating, encrypting and/or decrypting data is provided. The system includes at least one memory comprising computer executable instructions; and at least one processor configured to read and execute the computer executable instructions. The computer executable instructions cause the at least one processor to: generate vehicle data; generate a dynamic secret key based on a symmetric secret key stored at a first device and at least one from among information about a vehicle and information about a driver of a vehicle; and generate a message authentication code based on the generated dynamic secret key.

According to an aspect of another exemplary embodiment, a system for authenticating, encrypting and/or decrypting data is provided. The system includes at least one memory comprising computer executable instructions; and at least one processor configured to read and execute the computer executable instructions. The computer executable instructions cause the at least one processor to: generate vehicle data; generate a dynamic secret key based on a symmetric secret key stored at a first device and at least one from among information about a vehicle and information about a driver of a vehicle; and encrypt the vehicle data by using the generated dynamic secret key.

The computer executable instructions may further cause the at least one processor to: generate a message authentication code based on the generated dynamic secret key; add the message authentication code and encrypted vehicle data to a message; and transmit the message authentication code and the message to a second device

The computer executable instructions may further cause the at least one processor to: generate a message authentication code based on the generated dynamic secret key; and transmit the message authentication code to a second device.

The computer executable instructions may further cause the at least one processor to: receive the message authentication code and the message at the second device; generate a dynamic secret key based on a symmetric secret key stored at the second device and the at least one from among information about the vehicle and information about the driver of the vehicle; decrypt, at the second device, the encrypted vehicle data based on the generated dynamic secret key; and validate, at the second device, the message based on the message authentication code.

The information about a vehicle may include at least one from among identification information of an electronic controller unit, identification information of an electronic controller unit group, identification information corresponding to a network, identification information of a vehicle, and information corresponding to a vehicle function.

The information about a driver may include at least one from among identification information of the driver, authentication information of the driver, dynamically generated information based on driver actions, and vehicle settings corresponding to the driver.

The computer executable instructions may further cause the at least one processor to process the vehicle data at the second device in response to the message being validated based on the message authentication code.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that encrypts, decrypts or authenticates data according to an exemplary embodiment;

FIG. 2 shows a flowchart for a method of authenticating data by generating a message authentication code to validate data according to an exemplary embodiment;

FIG. 3 shows a flowchart for a method of authenticating data based on a received message authentication code according to an exemplary embodiment; and

FIG. 4 shows flow diagram of encrypting and decrypting data in an embedded vehicle network according to an aspect of an exemplary embodiment.

### DETAILED DESCRIPTION

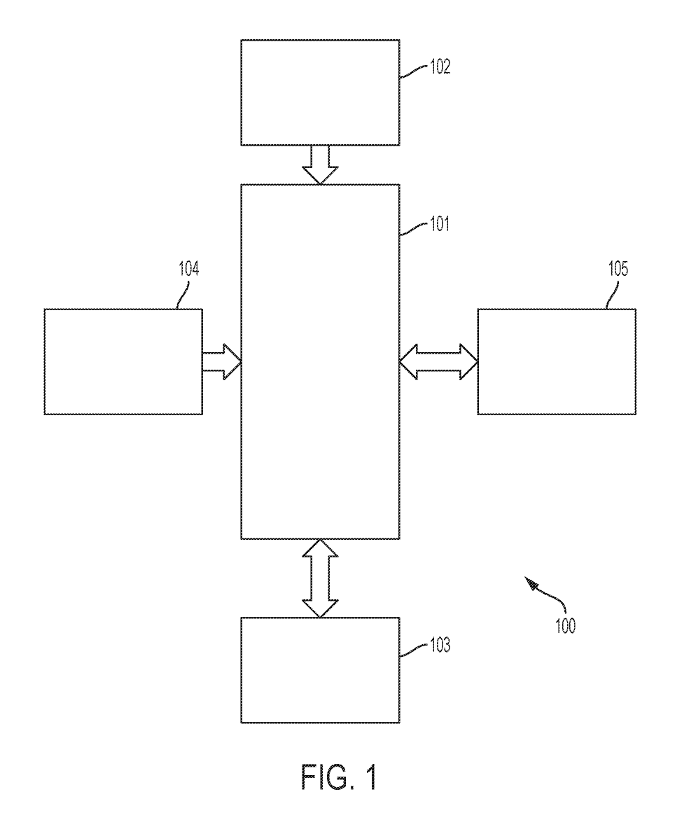

An apparatus and method that encrypt, decrypt and authenticate data will now be described in detail with reference to FIGS. 1-4 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or combined into one or more devices. In addition, individual elements may be provided on separate devices.

Encrypting data to be transmitted across communication networks is performed to ensure secure transmission of data and information by making exchanged data unrecognizable to anyone that views the data without decrypting the data. In addition, message authentication codes (MACs) may be generated according to an algorithm based on variables known only to a transmitting device and/or a receiving device to ensure that a received message was sent from a trusted source. Moreover, authentication and encryption may be used to ensure that data remains secret and ensure that the data is being sent by a trusted source. The use of MACs reduces the likelihood that an unauthorized source can spoof a legitimate source by sending a message with the MAC of a legitimate source. For example, certain critical messages transmitted between electronic controller units (ECUs) via in-vehicle Local Area Networks (LANs) must be authenticated to ensure that the data contained in those messages is from a trusted source.

To authenticate messages, the transmitter of these messages is responsible for generating a MAC and placing it in the payload of the message prior to transmission. The receiver of these messages may then successfully verify the MAC before accepting the received data for functional processing. MACs may be generated using a secret symmetric key shared between the transmitter and receiver(s) of a message. The secret key may be a 128 bit, 192 bit or 256 bit secret key. However, the secret key is not limited to aforementioned configurations and may vary in length.

In symmetric key encryption, a transmitter and a receiver both have a copy of a same secret key that is used to encrypt, decrypt and/or authenticate the data. The symmetric secret key does not change and must remain secret so as not to expose the encrypted data. Moreover, a dynamic key is generated according to variables and algorithms that are known to both the sender and the receiver. The generated dynamic key may then be used to encrypt, decrypt, and/or authenticate data. Thus, a dynamic key may change over time due to changing variables. As such vehicle and driver dynamic data may hinder the effectiveness of an outside attack because an attacker would need to consider instant access to the information, the knowledge of which variables should be monitored to generate the dynamic key, how each variable influences on the dynamic key computation, the original symmetric secret key stored on the non-volatile memory, and the cryptographic algorithms being used.

According to one example, a security peripheral (e.g. a secure hardware extension (SHE)) may be used for cryptographic hardware acceleration, secure key storage and secure key restrictions. The SHE may provide an application layer with a fixed set of cryptographic services based on AES. For example, encryption & decryption, cipher-based message authentication code (CMAC) generation & verification, random number generation, boot loader verification, and/or unique device identification.

A symmetric secret key and certificate may be stored in a dedicated memory, such as a non-volatile memory, that is not accessible by the application and that is only accessible by the security peripheral control logic. Keys stored in the secure memory may be referenced by an index (e.g., from 0 to 14) and updated in the secure memory with a specific procedure. According to an example, a memory may serve as storage for twenty 128-bit general purpose keys which can be used for encryption, decryption, or MAC generation and/or verification.

According to another example, separating authenticated messages into virtual groups allow for fine grain separation of secrets (keys) to limit the damage of an exposed secret key. The virtual groups may be formed from traditional symmetric cryptography by assigning the same secret symmetric key to a restricted group of ECUs (or entities). In one example, dynamic keys may be generated based on key-variables deemed to be important to specific elements operations and/or communications. The generation of these dynamic keys would allow the virtual groups to be further separated according to the key-variables deemed important to those specific elements' communications.

FIG. 1 shows a block diagram of an apparatus that encrypts, decrypts or authenticates data 100 according to an exemplary embodiment. As shown in FIG. 1, the apparatus that encrypts, decrypts or authenticates data 100, according to an exemplary embodiment, includes a controller 101, a power supply 102, a storage 103, a vehicle information input 104, and a communication device 105. However, the apparatus that encrypts decrypts or authenticates data 100 is not limited to the aforementioned configuration and may be configured to include additional elements and/or omit one or more of the aforementioned elements. The apparatus that encrypts, decrypts or authenticates data 100 may be implemented as part of a vehicle, as part of a vehicle (ECU), or as a standalone component.

The controller 101 controls the overall operation and function of the apparatus that encrypts, decrypts or authenticates data 100. The controller 101 may control one or more of the power supply 102, the storage 103, the vehicle information input 104, and the communication device 105 of the apparatus that encrypts and decrypts data. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the vehicle information input 104, and the communication device 105 of the apparatus that encrypts, decrypts or authenticates data 100. The information may be sent and received via a bus or network, or may be directly read or written to/from one or more of the storage 103, the vehicle information input 104, and the communication device 105 of the apparatus that encrypts, decrypts or authenticates data 100. Examples of suitable network connections include a controller area network (CAN), a media oriented system transfer (MOST), a local interconnection network (LIN), a local area network (LAN), and other appropriate connections such as Ethernet.

The power supply 102 provides power to one or more of the controller 101, the storage 103, the vehicle information input 104, and the communication device 105 of the apparatus that encrypts, decrypts or authenticates data 100. The power supply 102 may include one or more from among a battery, an outlet, a capacitor, a solar energy cell, a generator, a wind energy device, an alternator, etc.

The storage 103 is configured for storing information and retrieving information used by the apparatus that encrypts, decrypts or authenticates data 100. The storage 103 may be controlled by the controller 101 to store and retrieve information including encryption, decryption and authentication algorithms, symmetric keys, dynamic keys, among information about a vehicle, and information about a driver of a vehicle. The information on the driver of the vehicle may include identification information of the driver, authentication information of the driver, and vehicle settings corresponding to the driver. The information about the vehicle may include at least one from among identification information of an electronic controller unit, identification information of an electronic controller unit group, identification information corresponding to a network, identification information of a vehicle, and information corresponding to a vehicle function. The storage 103 may also include the computer instructions configured to be executed by a processor to perform the functions of the apparatus that encrypts, decrypts or authenticates data 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The vehicle information input 104 is configured to receive information from one or more of vehicle diagnostics modules, engine control modules, powertrain control module, body control module, and human machine interface module. The information may be received over an intra-vehicle communication network, such as using a controller area network (CAN) bus, or any other type of network and/or protocol or via the communication device 105.

The engine control modules may control various aspects of engine operation such as fuel ignition and ignition timing and may provide information on the various engine components. Powertrain control modules may regulate operation of one or more components of the vehicle powertrain and may provide information on components of the vehicle powertrain. A body control module may control various electrical components located throughout the vehicle, like the vehicle's power door locks and headlights and may provide information on the electrical components. A vehicle diagnostics module may provide data from one or more sensors equipped in a vehicle. For example, the vehicle may be equipped with sensors such as one or more from among tire sensors, brake sensors, fluids sensors, and various other sensors that monitor the performance of corresponding components of the vehicle. The vehicle diagnostic module receives data from the sensors over an intra-vehicle communication network, such as using a controller area network (CAN) bus, or any other type of network and/or protocol. By monitoring the data from the sensors, the vehicle diagnostic module may then provide the information to the vehicle information input 104.

The communication device 105 may be used by the apparatus that encrypts, decrypts or authenticates data 100 to communicate with various types of external apparatuses according to various communication methods. The communication device 105 may be used to send/receive information to/from the controller 101 of the apparatus that encrypts, decrypts or authenticates data 100. Examples of information to be sent or received may include a MAC, encrypted and unencrypted data. The communication device 105 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long term evolution (LTE), Bluetooth, EVDO, CDMA, GPRS, EDGE or ZigBee.

An output (not shown) may be used to output information in one or more forms including: visual, audible and/or haptic form. The output may be controlled by the controller 101 to provide outputs to the user of the apparatus that encrypts, decrypts or authenticates data 100. The output may include one or more from among a speaker, a display, a transparent display, a centrally-located display, a head up display, a windshield display, a haptic feedback device, a vibration device, a tactile feedback device, a tap-feedback device, a holographic display, an instrument light, an indicator light, etc. The output may output a notification including one or more from among an audible notification, a light notification, and a display notification.

A user input (not shown) may configured to provide information and commands to the apparatus that encrypts, decrypts or authenticates data 100. The user input may be used to provide user inputs, etc., to the controller 101. The user input may include one or more from among a touchscreen, a keyboard, a soft keypad, a button, a motion detector, a voice input detector, a microphone, a camera, a trackpad, a mouse, a touchpad, etc. The user input may be configured to receive a user input including information on the driver of the vehicle and information on the vehicle.

The controller 101 of the apparatus that encrypts, decrypts or authenticates data 100 may be configured to receive or generate vehicle data based on information from vehicle sensors; generate a dynamic secret key based on a symmetric secret key stored at a first device and at least one from among information about a vehicle and information about a driver of a vehicle; and generate a message authentication code to authenticate the vehicle data by using the generated dynamic secret key.

The controller 101 of the apparatus that encrypts, decrypts or authenticates 100 may also be configured to encrypt the vehicle data based on the generated dynamic secret key; add the message authentication code and encrypted vehicle data to a message; and transmit the message authentication code and the message to a second device.

The controller 101 of the apparatus that encrypts, decrypts or authenticates 100 may also be configured to add the message authentication code to a message; and transmit the message authentication code and the message to a second device.

The controller 101 of the apparatus that encrypts, decrypts or authenticates data 100 may be configured to receive the message authentication code and the message at the second device; generate a dynamic secret key based on a symmetric secret key stored at the second device and the at least one from among information about the vehicle and information about the driver of the vehicle; decrypt, at the second device, the encrypted vehicle data based on the generated dynamic secret key; and validate, at the second device, the message based on the message authentication code. The validation may be performed by determining or calculating a message authentication code at a second device based on information the at least one from among information about the vehicle and information about the driver of the vehicle and comparing the determined or calculated message authentication code to the received message authentication code.

The controller 101 of the apparatus that encrypts, decrypts or authenticates data 100 may also be configured to process the message payload at the second device in response to the message payload being authenticated based on the message authentication code.

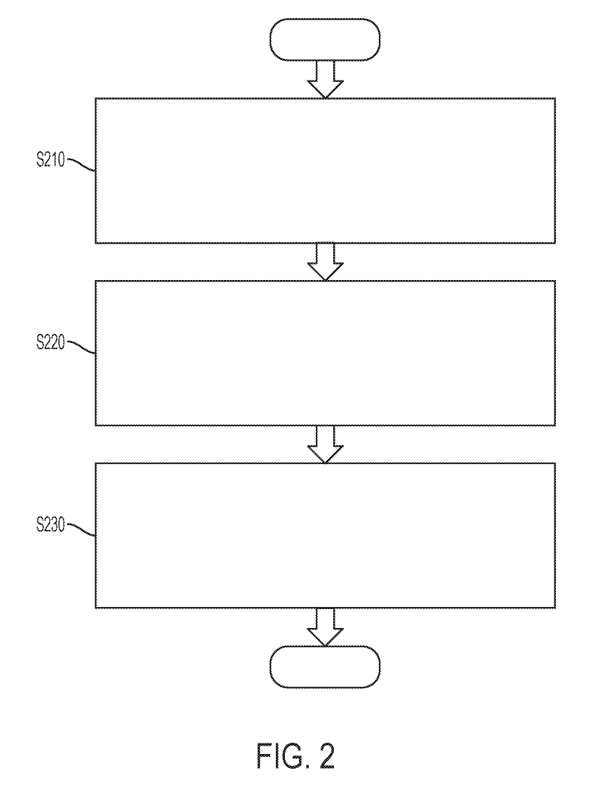

FIG. 2 shows a flowchart for a method of authenticating data by generating a message authentication code to validate data according to an exemplary embodiment. The method of FIG. 2 may be performed by the apparatus encrypts, decrypts or authenticates data 100 or may be encoded into a computer readable medium as instructions that are executable by a computer to perform the method.

Referring to FIG. 2, a vehicle data is generated based on information detected at a vehicle component in operation S210. A dynamic secret key is generated based on a symmetric secret key stored at a first device and at least one from among information about the vehicle and information about the driver of the vehicle in operation S220. In operation S230, a message authentication code is generated by using the generated dynamic secret key. The message authentication code may be transmitted to second device with data and used by the second device to validate the data.

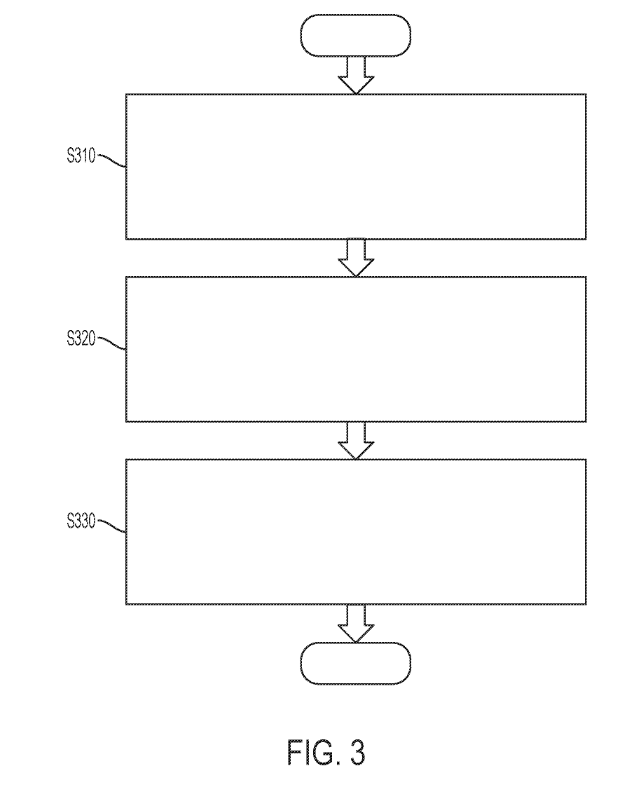

FIG. 3 shows a flowchart for a method of authenticating data based on a received message authentication code according to an exemplary embodiment. The method of FIG. 3 may be performed by the apparatus that encrypts, decrypts or authenticates 100 or may be encoded into a computer readable medium as instructions that are executable by a computer to perform the method.

Referring to FIG. 3, a message authentication code and message payload is received at a second device in operation S310. The message authentication code and message payload may be received from a first device. A dynamic secret key is generated based on a symmetric secret key stored at a second device and at least one from among information about the vehicle and information about the driver of the vehicle in operation S320. In operation S330, a message authentication code is determined by using the generated dynamic secret key and the received message authentication code is validated. The message payload is authenticated based on the determined message authentication code in operation S330. For example, the determined message authentication code may be compared to the received message authentication code to validate the received data.

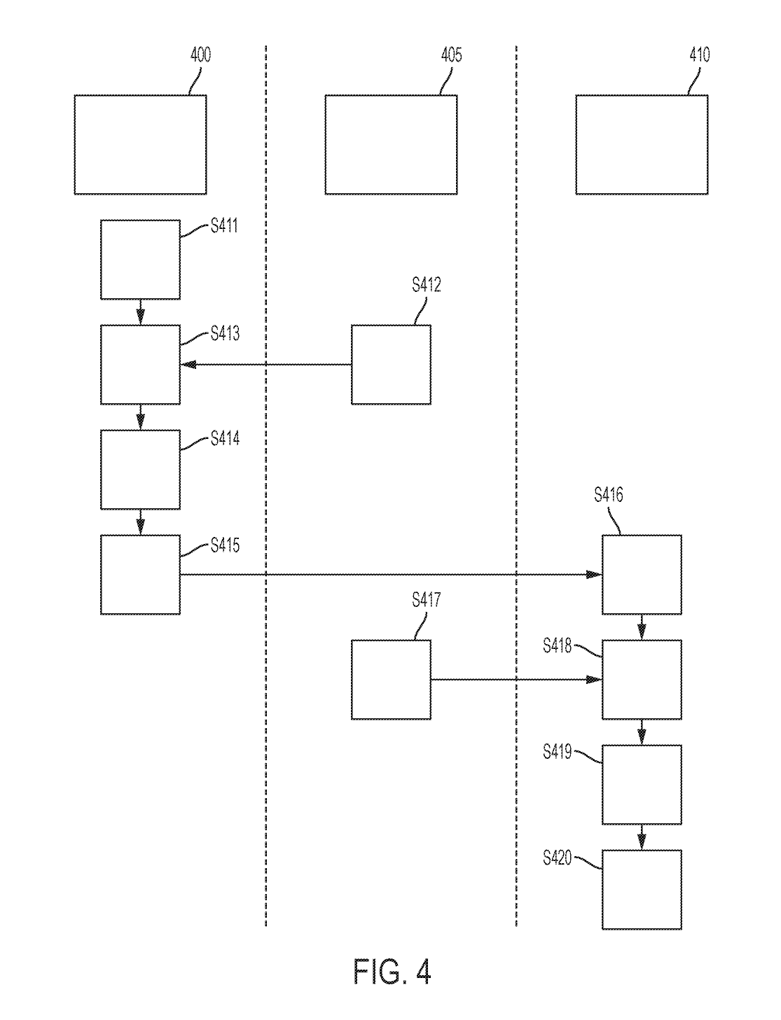

FIG. 4 shows flow diagram of encrypting and decrypting data in an embedded vehicle network according to an aspect of an exemplary embodiment. The method of FIG. 4 may be performed by the apparatus that encrypts, decrypts or authenticates data 100 or may be encoded into a computer readable medium as instructions that are executable by a computer to perform the method.

Referring to FIG. 4, the flow of information between a first ECU 400, a vehicle and driver information input 405 and a second ECU 410 is shown. In operation S411, vehicle data is generated based on information detected at a vehicle component such as the first ECU 400. In operation S413, a dynamic secret key is generated based on a symmetric secret key stored at the first ECU 400 and at least one from among information about the vehicle and information about the driver of the vehicle received from the vehicle and driver information input 405 in operation S412. The vehicle data is encrypted by using the generated dynamic secret key in operation S414 and placed in a message payload that is transmitted to the second ECU 410 in operation S415. In one example, the message payload that is transmitted to the second ECU 410 with a message authentication code(optional) in operation S415. In another example, the message authentication code may also be generated based on the generated dynamic secret key.

The second ECU 410 receives the message authentication code and encrypted message payload from the first ECU 400 in operation S416. In operation S418, a dynamic secret key is generated at the second ECU 410 based on a symmetric secret key stored at the second ECU 410 and at least one from among information about a vehicle and information about a driver of a vehicle received from the vehicle information input 405 in operation S417. The encrypted message payload is then decrypted based on the generated dynamic secret key in operation S419.

In operation S420 (optional), the second ECU 410 validates the received message authentication code using a message authentication code determined at second ECU based on a symmetric secret key stored at the second ECU 410 and at least one from among information about a vehicle and information about a driver of a vehicle received from the vehicle information input 405. The message authentication code determined at second ECU may be compared to the message authentication code received from the first ECU.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for authenticating data, the method comprising:
generating vehicle data based on information detected at a vehicle component;
generating a dynamic secret key based on a symmetric secret key stored at a first device and at least one from among information about a vehicle and information about a driver of a vehicle; and
generating a message authentication code to authenticate the vehicle data by using the generated dynamic secret key.

2. The method of claim 1, wherein the information about a vehicle includes at least one from among identification information of an electronic controller unit, identification information of an electronic controller unit group, identification information corresponding to a network, identification information of a vehicle, and information corresponding to a vehicle function.

3. The method of claim 2, wherein the information about a driver includes at least one from among identification information of the driver, authentication information of the driver, dynamically generated information based on driver actions, and vehicle settings corresponding to the driver.

4. The method of claim 3, further comprising encrypting the vehicle data by using the generated dynamic secret key.

5. The method of claim 3, further comprising
adding the message authentication code to a message payload; and
transmitting the message payload to a second device.

6. The method of claim 3, further comprising:
generating a second dynamic secret key based on the symmetric secret key stored at the first device and the at least one from among information about the vehicle and information about the driver of a vehicle; and
encrypting the vehicle data by using the generated second dynamic secret key.

7. A non-transitory computer readable medium comprising computer executable instructions executable by a processor to perform the method of claim 1.

8. A method for authenticating data, the method comprising:
receiving vehicle data and a message authentication code at a second device;
generating a dynamic secret key based on a symmetric secret key stored at the second device and at least one from among information about a vehicle and information about a driver of a vehicle; and
validating the received message authentication code and vehicle data based on the generated dynamic secret key.

9. The method of claim 8, wherein the information about a vehicle includes at least one from among identification information of an electronic controller unit, identification information of an electronic controller unit group, identification information corresponding to a network, identification information of a vehicle, and information corresponding to a vehicle function.

10. The method of claim 9, wherein the information about a driver includes at least one from among identification information of the driver, authentication information of the driver, dynamically generated information based on driver actions, and vehicle settings corresponding to the driver.

11. The method of claim 10, wherein the vehicle data comprises encrypted vehicle data, the method further comprising:
decrypting the vehicle data by using the generated dynamic secret key.

12. The method of claim 11, further comprising
performing a vehicle function corresponding to the decrypted vehicle data at the second device in response to the message payload being validated based on the message authentication code.

13. The method of claim 10, further comprising:
generating a second dynamic secret key based on the symmetric secret key stored at the first device and the at least one from among information about the vehicle and information about the driver of a vehicle; and
decrypting the vehicle data by using the generated second dynamic secret key.

14. A non-transitory computer readable medium comprising computer executable instructions executable by a processor to perform the method of claim 7.

15. An encryption, decryption and authentication system, the system comprising:
at least one memory comprising computer executable instructions; and
at least one processor configured to read and execute the computer executable instructions, the computer executable instructions causing the at least one processor to:
generate vehicle data;
generate a dynamic secret key based on a symmetric secret key stored at a first device and at least one from among information about a vehicle and information about a driver of a vehicle; and
encrypt the vehicle data by using the generated dynamic secret key.

16. The apparatus of claim 15, wherein the computer executable instructions further causing the at least one processor to:
generate a message authentication code based on the generated dynamic secret key;
add the message authentication code and encrypted vehicle data to a message; and
transmit the message authentication code and the message to a second device

17. The apparatus of claim 16, wherein the computer executable instructions further causing the at least one processor to:
receive the message authentication code and the message at the second device;
generate a dynamic secret key based on a symmetric secret key stored at the second device and the at least one from among information about the vehicle and information about the driver of the vehicle;
decrypt, at the second device, the encrypted vehicle data based on the generated dynamic secret key; and
validate, at the second device, the message based on the message authentication code.

18. The apparatus of claim 17, wherein the information about a vehicle includes at least one from among identification information of an electronic controller unit, identification information of an electronic controller unit group, identification information corresponding to a network, identification information of a vehicle, and information corresponding to a vehicle function.

19. The apparatus of claim 18, wherein the information about a driver includes at least one from among identification information of the driver, authentication information of the driver, dynamically generated information based on driver actions, and vehicle settings corresponding to the driver.

20. The apparatus of claim 19, wherein the computer executable instructions further cause the at least one processor to process the vehicle data at the second device in response to the message being validated based on the message authentication code.
